(19) United States
(12) Patent Application Publication
(10) Pub. No.: US 2024/0089194 A1
(43) Pub. Date: Mar. 14, 2024

(54) Marking of RDMA-over-Converged-Ethernet (RoCE) Traffic Eligible for Adaptive Routing

(71) Applicant: MELLANOX TECHNOLOGIES, LTD., Yokneam (IL)

(72) Inventors: Ariel Almog, Kochav Yair (IL); Eitan Zahavi, Zichron Yaakov (IL); Idan Burstein, Akko (IL); Zachy Haramaty, Ramat Gan (IL); Aviv Barnea, Beerotaim (IL)

(21) Appl. No.: 17/990,686

(22) Filed: Nov. 20, 2022

Related U.S. Application Data
(60) Provisional application No. 63/404,551, filed on Sep. 8, 2022.

(51) Int. Cl. H04L 45/00; H04L 67/1097; H04L 69/22

(52) U.S. Cl. CPC H04L 45/22; H04L 45/66; H04L 67/1097; H04L 69/22

(57) ABSTRACT

A network adapter includes a port and one or more circuits. The port is to send packets to a network in accordance with a Remote Direct Memory Access over Converged Ethernet (RoCE) protocol. The one or more circuits are to decide whether a packet is permitted to undergo Adaptive Routing (AR) in being routed through the network, to mark the packet with an indication of whether the packet is permitted to undergo AR, and to send the marked packet to the network via the port.

### CROSS-REFERENCE TO RELATED APPLICATIONS

This application claims the benefit of U.S. Provisional Patent Application 63/404,551, filed Sep. 8, 2022, whose disclosure is incorporated herein by reference.

### FIELD OF THE INVENTION

The present invention relates generally to communication networks, and particularly to methods and systems for applying Adaptive Routing (AR) to Remote Direct Memory Access over Ethernet (RoCE) traffic.

### BACKGROUND OF THE INVENTION

RoCE, also referred to as InfiniBand over Ethernet (IBoE), is a network protocol that enables performing Remote Direct Memory Access (RDMA) transactions over an Ethernet network. Generally speaking, RoCE involves encapsulating InfiniBand (IB) transport packets in Ethernet packets. RoCE is specified, for example, in “Supplement to InfiniBand™ Architecture Specification—Volume 1 Release 1.2.1—Annex A17: RoCEv2,” Sep. 2, 2014.

Adaptive Routing (AR) techniques route traffic over multiple alternative routes in a network, for example depending on load conditions, congestion, or other conditions of the routes. Various AR techniques are known in the art. For example, U.S. Pat. No. 8,576,715, whose disclosure is incorporated herein by reference, describes routing using multiple routing modes, e.g., a time-bounded AR mode, an unbounded AR mode and a static routing mode. U.S. Pat. No. 9,014,006, whose disclosure is incorporated herein by reference, describes adaptive routing techniques that use inter-switch notifications. U.S. Pat. No. 9,894,005, whose disclosure is incorporated herein by reference, describes adaptive routing controlled by source node. Additional AR techniques are described, for example, in U.S. Pat. Nos. 9,973,435, 10,819,621, 10,178,029, 10,200,294, 10,644,995, whose disclosures are all incorporated herein by reference.

### SUMMARY OF THE INVENTION

A network adapter includes a port and one or more circuits. The port is to send packets to a network in accordance with a Remote Direct Memory Access over Converged Ethernet (RoCE) protocol. The one or more circuits are to decide whether a packet is permitted to undergo Adaptive Routing (AR) in being routed through the network, to mark the packet with an indication of whether the packet is permitted to undergo AR, and to send the marked packet to the network via the port.

In some embodiments, the one or more circuits are to decide whether the packet is permitted to undergo AR by negotiating with a peer network adapter at a destination of the packet, and finding whether the peer network adapter is capable of processing RoCE packets that are received Out-Of-Order (OOO). In an example embodiment, in response to receiving an override instruction from a host, the one or more circuits are to mark the packet as ineligible to undergo AR even though the peer network adapter is capable of processing RoCE packets received OOO. In another embodiment, in response to the packet meeting a defined condition, the one or more circuits are to mark the packet as ineligible to undergo AR regardless of whether the packet is eligible or not.

In some embodiments, the one or more circuits are to mark the packet by setting a bit in a transport-layer header of the packet. In an example embodiment, the bit is a reserved bit in a RoCE Base Transport Header (BTH) of the packet.

There is additionally provided, in accordance with an embodiment of the present invention, a network device including multiple ports and one or more packet processing circuits. The ports are to send and receive packets to and from a network in accordance with a RoCE protocol. The one or more packet processing circuits are to receive a packet, to extract from the packet an indication of whether the packet is permitted to undergo AR, and to route the packet using AR or using static routing, depending on the indication.

In some embodiments, the one or more packet processing circuits are to extract the indication by reading a bit in a transport-layer header of the packet. In an embodiment, the bit is a reserved bit in a RoCE Base Transport Header (BTH) of the packet. In a disclosed embodiment, the network device is a layer-2 switch, and the one or more packet processing circuits are to extract the indication by reading a bit in a transport-layer header of the packet.

There is also provided, in accordance with an embodiment of the present invention, a method for communicating Remote Direct Memory Access over Converged Ethernet RoCE packets. The method includes, in a network adapter, deciding whether a RoCE packet is permitted to undergo AR in being routed through a network. The RoCE packet is marked in the network adapter with an indication of whether the packet is permitted to undergo AR. The marked packet is sent from the network adapter to the network.

There is also provided, in accordance with an embodiment of the present invention, a method for routing RoCE packets. The method includes receiving a RoCE packet from a network in a network device. An indication of whether the packet is permitted to undergo AR is extracted from the packet. The packet is routed using AR or using static routing, depending on the indication.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an Ethernet communication system, in accordance with an embodiment of the present invention;

FIG. 2 is a flow chart that schematically illustrates a method for transmitting RoCE packets having Adaptive Routing (AR) eligibility marks from an Ethernet Network Interface Controller (NIC), in accordance with an embodiment of the present invention; and

FIG. 3 is a flow chart that schematically illustrates a method for routing RoCE packets having Adaptive Routing (AR) eligibility marks in an Ethernet switch, in accordance with an embodiment of the present invention.

### DETAILED DESCRIPTION OF EMBODIMENTS

### Overview

Adaptive Routing (AR) techniques are routing techniques in which a network device, e.g., a network switch, is given freedom to choose a routing path for a packet from among multiple candidate routes. AR allows better utilization of network resources, e.g., by improving load balancing and avoiding congestion. On the other hand, switching from one route to another may cause packets to arrive at their destination Out-Of-Order (OOO), i.e., in an order that differs from the order of transmission from the source. OOO packet arrival may be problematic, and sometimes forbidden, for some applications.

RoCE is one typical example of an application that may have difficulty in processing packets that arrive OOO. Some Ethernet Network Interface Controllers (NICs) are capable of processing RoCE packets that arrive OOO, while other NICs require strict in-order arrival.

Embodiments of the present invention that are described herein provide improved methods and systems for communicating RoCE traffic. In the disclosed embodiments, a source NIC transmits RoCE packets to an Ethernet network. Among other packet processing tasks, the source NIC decides, for a given RoCE packet, whether or not the packet is permitted to undergo AR in being routed through the network. The source NIC then marks the packet with a suitable “eligibility mark”, and transmits the marked packet to the network. The terms “permitted to undergo AR” and “eligible for AR” are used interchangeably herein.

In some embodiments, a network switch that supports the disclosed techniques is located at a location in the network having multiple alternative routes leading to the destination of the above-described packet. Upon receiving the packet, the switch extracts the eligibility mark from the packet and identifies whether the packet is permitted to undergo AR or not. If permitted, the switch routes the packet using AR. If not permitted, the switch routes the packet using static routing.

In the present context, the term “adaptive routing” refers to a routing scheme in which a network device (e.g., switch or router) has the freedom to route a given packet or flow over one of multiple different candidate routes, and to change the route selection over time. From the perspective of the switch, adaptive selection of a route from among candidate routes is equivalent to adaptive selection of an egress port for a packet or flow from a set of alternative egress ports. The term “static routing” refers to a routing scheme in which a network device (e.g., switch or router) selects the same route for a given packet or flow.

In an embodiment, the source NIC marks the packet with an eligibility mark by setting a reserved bit in a Base Transport Header (BTH) of the packet. The BTH is a layer-4 (transport layer) header, which is part of an inner IB packet of the RoCE packet. In an embodiment, the switch extracts the eligibility mark by examining the inner layer-4 IB header, even though the switch itself is a layer-2 Ethernet switch and the IB packet is encapsulated in an Ethernet packet.

The source NIC may use various criteria for deciding whether a given RoCE packet is eligible to undergo AR or not. In some embodiments, when initiating communication, the source NIC and the destination NIC carry out an auto-negotiation process in which the NICs report their capabilities to one another. One of the reported capabilities is whether or not the destination NIC is capable of processing RoCE packets that arrive OOO. When sending packets to a destination NIC that supports OOO packet arrival, the source NIC marks the packets as eligible to undergo AR, and vice versa.

In some embodiments, the host served by the source NIC may override the NIC in making AR eligibility decisions for packets. Additionally or alternatively, the source NIC may force static routing for specific packets within a flow that is specified as eligible for AR.

In summary, the methods and systems described herein ensure that AR is applied only to RoCE traffic that is permitted to undergo AR. Without the disclosed techniques, either all destination NICs must support OOO processing of received RoCE traffic, or else AR cannot be used.

### System Description

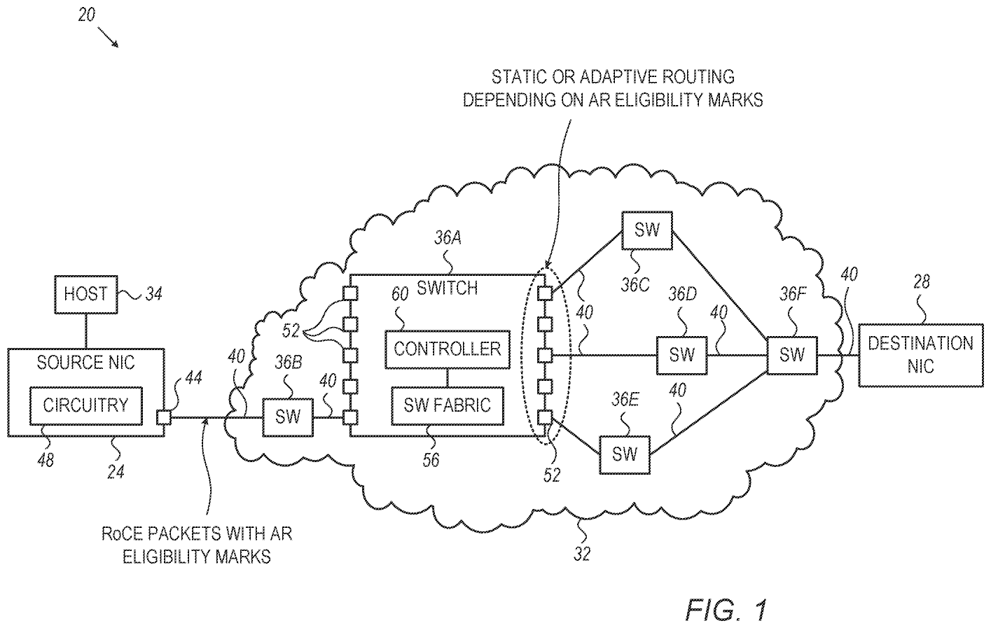

FIG. 1 is a block diagram that schematically illustrates an Ethernet communication system 20, in accordance with an embodiment of the present invention. System 20 comprises Ethernet NICs 24 and 28 that communicate with one another using RoCE over an Ethernet network 32. NIC 24 serves a host 34. Network 32 comprises a plurality of Ethernet switches, in the present example six switches denoted 36A-36F, which are interconnected by network links 40.

In the demonstrative examples below, NIC 24 sends RoCE packets to NIC 28. Therefore, NIC 24 is referred to as a source NIC, and NIC 28 is referred to as a destination NIC. NIC 24 comprises a port 44 for sending and receiving packets to and from network 32, and circuitry 48, comprising one or more circuits, for generating and otherwise processing transmitted and received packets. Among other tasks, circuitry 48 marks outgoing RoCE packets with “AR eligibility indications,” which indicate whether or not the RoCE packets are permitted to undergo Adaptive Routing (AR).

As shown in detail for switch 36A, each Ethernet switch in network 32 comprises multiple ports 52, a switch fabric 56, and a controller 60. Ports 52 serve as network interfaces for transmitting and receiving packets to and from network 32. Fabric 56 forwards packets between the ports—A given packet is received at a certain ingress port and is forwarded to a certain egress port. Controller 60 configures and manages the operation of fabric 56 and of switch 36A as a whole.

Fabric 56 and controller 60 are referred to jointly as “packet processing circuitry” or “one or more packet processing circuits” that carry out the disclosed techniques. Among other tasks, the (one or more) packet processing circuits extract AR eligibility marks from incoming RoCE packets, and use the eligibility marks to decide whether to route the packets using AR or using static routing.

The configurations of system 20, network 32, NIC 24 and switch 36A, as depicted in FIG. 1, are example configurations that are chosen purely for the sake of conceptual clarity. Any other suitable configurations can be used in alternative embodiments. For example, FIG. 1 shows only two NICs for the sake of clarity. Real-life systems typically comprise a large number of NICs, each serving as a source NIC for some packets and as a destination NIC for other packets.

In various embodiments, NIC 24 and switch 36A may be implemented using suitable software, using suitable hardware such as one or more Application-Specific Integrated Circuits (ASIC) or Field-Programmable Gate Arrays (FPGA), or using a combination of hardware and software. Some elements of NIC 24 and/or switch 36A, e.g., controller 60 and/or parts of NIC circuitry 48, may be implemented using one more general-purpose processors, which are programmed in software to carry out the techniques described herein. The software may be downloaded to the processors in electronic form, over a network, for example, or it may, alternatively or additionally, be provided and/or stored on non-transitory tangible media, such as magnetic, optical, or electronic memory.

### Selective Application of AR by Marking Packets with AR Eligibility Marks

Consider an example scenario in which source NIC 24 sends RoCE packets addressed to destination NIC 28. As the packets travel through network 32, they are received by switch 36A. As seen in the figure, switch 36A is able to route packets to destination NIC 28 over three alternative routes—One route passing via switch 36C, another route passing via switch 36D, and a third route via switch 36E. All three routes converge at switch 36F, which is the last-hop switch connected to destination NIC 28.

To route a packet via a selected route, fabric 56 of switch 36A forwards the packet to an egress port leading to that route. When using static routing, the selection of egress port for a given packet (e.g., for a given flow defined by a respective “tuple”) is fixed. When using AR, controller 60 may change the selection of egress port for a given packet from time to time, e.g., depending on load conditions over the various alternative routes. Any suitable AR scheme can be used, e.g., the AR techniques in the references cited in the Background section above.

In some cases, it is permissible for switch 36A to route RoCE packets to destination NIC 28 using AR. In other cases, it is mandatory that RoCE packets be routed to destination NIC 28 using static routing. For example, destination NIC 28 may or may not be capable of processing RoCE packets that arrive Out-Of-Order (OOO), i.e., in a different order than the order in which they were sent from source NIC 24.

Thus, in some embodiments source NIC 24 marks each RoCE packet with an “eligibility mark” that indicates whether the packet is permitted to undergo AR. Switch 36A (and any other switch in network 32 that supports the disclosed technique) uses these marks to decide whether to route the packets using AR or using static routing.

In some embodiments, circuitry 48 of NIC 24 marks a RoCE packet with an eligibility mark by setting the value of a reserved bit in a Base Transport Header (BTH) of the inner IB packet in the RoCE packet. The structure of the BTH is specified, for example, in “InfiniBand™ Architecture Specification Volume 1—Release 1.5,” Jun. 2, 2021, Table 6. The table specifies a seven-bit “Reserved” field. Any of the bits of this field, e.g., the Most Significant Bit (MSB), can be used for storing an eligibility mark. In an example embodiment, setting this bit to “1” means that the packet is eligible for AR (permitted to undergo AR), and setting the bit to “0” means that the packet is ineligible for AR (not permitted to undergo AR). In alternative embodiment, any other suitable bit or multiple bits, in any other location in the packet, can be used for storing the eligibility mark for the packet.

In some embodiments, source NIC 24 marks some RoCE packets as eligible for AR, and other RoCE packets as ineligible for AR. For example, source NIC 24 may communicate with multiple destination NICs 28, some of which supporting processing of OOO packets and others do not.

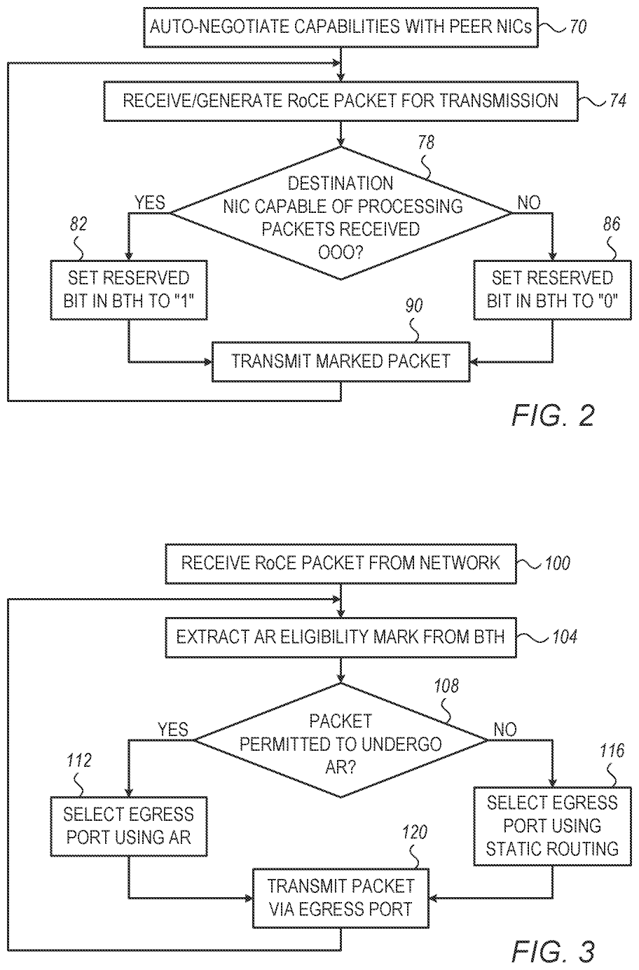

FIG. 2 is a flow chart that schematically illustrates a method for transmitting RoCE packets having Adaptive Routing (AR) eligibility marks from source NIC 24, in accordance with an embodiment of the present invention. The method begins with circuitry 48 of source NIC 24 carrying out auto-negotiation processes with one or more peer NICs, at an auto-negotiation stage 70. For convenience, the auto-negotiation processes are mentioned in a single stage of the method. In reality, auto-negotiation processes with different peer NICs will typically be conducted at different times—Upon establishing a connection with each peer NIC. As part of the auto-negotiation process, each peer NIC notifies NIC 24 whether or not it is capable of processing RoCE packets that arrive OOO.

At a packet generation stage 74, circuitry 48 of source NIC 24 generates (or receives from host 34 for transmission) a RoCE packet addressed to a certain destination NIC 28. At a capability checking stage 78, circuitry 48 checks (based on the results of the auto-negotiation process of stage 70) whether the destination NIC is capable of processing RoCE packets that arrive OOO.

If the destination NIC is found to be capable of processing RoCE packets that arrive OOO, circuitry 48 marks the RoCE packet with the appropriate eligibility mark, at an eligibility marking stage 82. In the present example circuitry 48 sets the MSB of the Reserved field in the BTH of the packet to “1”. If, on the other hand, the destination NIC is found to be incapable of processing RoCE packets that arrive OOO, circuitry 48 marks the RoCE packet with the opposite eligibility mark, at an ineligibility marking stage 86. In the present example circuitry 48 sets the MSB of the Reserved field in the BTH of the packet to “0”.

At a packet transmission stage 90, circuitry 48 sends the RoCE packet, including the eligibility mark, via port 44 to network 32. The method then loops back to stage 74 above for handling the next packet.

FIG. 3 is a flow chart that schematically illustrates a method for routing RoCE packets having AR eligibility marks in Ethernet switch 36A, in accordance with an embodiment of the present invention. The method begins with switch 36A receiving from network 32 a RoCE packet that is marked with an AR eligibility mark, at a packet reception stage 100.

At a mark extraction stage 104, fabric 56 of switch 36A extracts the eligibility mark from the packet. At an eligibility checking stage 108, fabric 56 checks whether, according to the extracted eligibility mark, the packet is permitted to undergo AR.

If the packet is permitted to undergo AR, fabric 56 selects an egress port for the packet using AR, at an adaptive routing stage 112. If the packet is not permitted to undergo AR, fabric 56 selects an egress port for the packet using static routing, at a static routing stage 116. At a forwarding stage 120, fabric 56 forwards the RoCE packet to the selected egress port, to be transmitted over the selected route in network 32.

The methods of FIGS. 2 and 3 are example methods that are chosen purely for the sake of conceptual clarity. In alternative embodiments, the disclosed techniques can be carried out using any other suitable method. For example, circuitry 48 of source NIC 24 may use any other suitable criterion for deciding whether a particular RoCE packet, or a particular flow of RoCE packets, is permitted to undergo AR or not.

In some embodiments, host 34 may override source NIC 24 in making AR eligibility decisions for packets. For example, source NIC 24 may find by auto-negotiation that destination NIC 28 is capable of processing RoCE packets that arrive OOO, and thus decide to mark the RoCE packets sent to NIC 28 as eligible for AR. Host 34 may override this decision and instruct NIC 24 to mark the RoCE packets sent to NIC 28 as ineligible for AR. In some embodiments, source NIC 24 may force static routing for specific packets within a flow that is specified as eligible for AR.

Scenarios in which host 34 may override an AR eligibility decision of NIC 24, and/or force static routing for specific packets, may comprise, for example:
Host 34 is aware that destination NIC 28 is capable of processing RoCE packets that arrive OOO, even though the destination NIC does not advertise this capability in auto-negotiation.
Auto-negotiation fails, and host 34 decides to use AR irrespective of the lack of knowledge as to the destination NIC capabilities.
Host 34 is aware that the destination NIC is missing certain hardware (e.g., a legacy NIC having no hardware for special CRC checking). In such a case host 34 may force static routing.

Although the embodiments described herein mainly address routing of RoCE packets over an Ethernet network, the methods and systems described herein can also be used in other applications, such as in native IB.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network adapter, comprising:
a port, to send packets to a network in accordance with a Remote Direct Memory Access over Converged Ethernet (RoCE) protocol; and
one or more circuits, to decide whether a packet is permitted to undergo Adaptive Routing (AR) in being routed through the network, to mark the packet with an indication of whether the packet is permitted to undergo AR, and to send the marked packet to the network via the port.

2. The network adapter according to claim 1, wherein the one or more circuits are to decide whether the packet is permitted to undergo AR by negotiating with a peer network adapter at a destination of the packet, and finding whether the peer network adapter is capable of processing RoCE packets that are received Out-Of-Order (OOO).

3. The network adapter according to claim 2, wherein, in response to receiving an override instruction from a host, the one or more circuits are to mark the packet as ineligible to undergo AR even though the peer network adapter is capable of processing RoCE packets received OOO.

4. The network adapter according to claim 1, wherein, in response to the packet meeting a defined condition, the one or more circuits are to mark the packet as ineligible to undergo AR regardless of whether the packet is eligible or not.

5. The network adapter according to claim 1, wherein the one or more circuits are to mark the packet by setting a bit in a transport-layer header of the packet.

6. The network adapter according to claim 5, wherein the bit is a reserved bit in a RoCE Base Transport Header (BTH) of the packet.

7. A network device, comprising:
multiple ports, to send and receive packets to and from a network in accordance with a Remote Direct Memory Access over Converged Ethernet (RoCE) protocol; and
one or more packet processing circuits, to receive a packet, to extract from the packet an indication of whether the packet is permitted to undergo Adaptive Routing (AR), and to route the packet using AR or using static routing, depending on the indication.

8. The network device according to claim 7, wherein the one or more packet processing circuits are to extract the indication by reading a bit in a transport-layer header of the packet.

9. The network device according to claim 8, wherein the bit is a reserved bit in a RoCE Base Transport Header (BTH) of the packet.

10. The network device according to claim 7, wherein the network device is a layer-2 switch, and wherein the one or more packet processing circuits are to extract the indication by reading a bit in a transport-layer header of the packet.

11. A method for communicating Remote Direct Memory Access over Converged Ethernet (RoCE) packets, the method comprising:
in a network adapter, deciding whether a RoCE packet is permitted to undergo Adaptive Routing (AR) in being routed through a network;
marking the RoCE packet in the network adapter with an indication of whether the packet is permitted to undergo AR; and
sending the marked packet from the network adapter to the network.

12. The method according to claim 11, wherein deciding whether the packet is permitted to undergo AR comprises negotiating with a peer network adapter at a destination of the packet, and finding whether the peer network adapter is capable of processing RoCE packets that are received Out-Of-Order (OOO).

13. The method according to claim 12, wherein marking the packet comprises, in response to receiving an override instruction from a host, marking the packet as ineligible to undergo AR even though the peer network adapter is capable of processing RoCE packets received OOO.

14. The method according to claim 11, wherein marking the packet comprises, in response to the packet meeting a defined condition, marking the packet as ineligible to undergo AR regardless of whether the packet is eligible or not.

15. The method according to claim 11, wherein marking the packet comprises setting a bit in a transport-layer header of the packet.

16. The method according to claim 15, wherein the bit is a reserved bit in a RoCE Base Transport Header (BTH) of the packet.

17. A method for routing Remote Direct Memory Access over Converged Ethernet (RoCE) packets, the method comprising:
in a network device, receiving a RoCE packet from a network;
extracting from the packet an indication of whether the packet is permitted to undergo Adaptive Routing (AR);
routing the packet using AR or using static routing, depending on the indication.

18. The method according to claim 17, wherein extracting the indication comprises reading a bit in a transport-layer header of the packet.

19. The method according to claim 18, wherein the bit is a reserved bit in a RoCE Base Transport Header (BTH) of the packet.

20. The method according to claim 17, wherein the network device is a layer-2 switch, and wherein extracting the indication comprises reading a bit in a transport-layer header of the packet.
